(19) United States
(12) Patent Application Publication
(10) Pub. No.: US 2024/0378404 A1
(43) Pub. Date: Nov. 14, 2024

(54) TESTING AND ADJUSTING AN RFID READING DEVICE

(71) Applicant: SICK AG, Waldkirch (DE)

(72) Inventor: Florian PUDENZ, Waldkirch (DE)

(21) Appl. No.: 18/618,276

(22) Filed: Mar. 27, 2024

(30) Foreign Application Priority Data
May 9, 2023 (EP) 23172289.3

(51) Int. Cl. G06K 7/10

(52) U.S. Cl. CPC G06K 7/10366

(57) ABSTRACT

A method of testing and adjusting an RFID reading device is provided that has an internal antenna and/or an external antenna connected via a connection line, wherein at least one RFID signal is transmitted between the RFID reading device and at least one RFID transponder over the antenna, and wherein the RFID reading device recognizes which antenna is connected, In this respect, the RFID reading device compares the connected antenna and/or the connection line with antennas connectable to the RFID reading device and/or with connection lines of an antenna list to identify an antenna and/or connection line that improves the transmission of the RFID signal and the identified antenna and/or connection line is/are displayed to a user of the RFID reading device.

The invention relates to a method of testing and adjusting an RFID reading device and to a corresponding RFID reading.

RFID reading devices or more abbreviated RFID readers serve for the identification of objects and products and are used inter alia to automate logistical movements. RFID transponders fastened to the products are read at an identification point, above all on a change of the owner of the product or on a change of the transport means, and information is optionally written back into the transponder. This results in fast and traceable logistical movements. The detected information is used to control the forwarding and sorting of goods and products. Important applications for automatic identification are logistics distribution centers, for instance of parcel shippers, or the baggage check-in at airports.

An RFID reading device excites RFID transponders located in its reading range by electromagnetic radiation via its antenna to emit the stored information, receives the corresponding transponder signals, and evaluates them. For this purpose, the UHF (ultra-high frequency) range is frequently used since there is an established framework here with the standard ISO 18000-6 and in addition transponders at different distances from some millimeters up to several meters can be read. UHF RFID transponders are available in very compact construction designs and can also accordingly be attached to very small objects.

The RFID reading device uses an internal or external antenna, with an external antenna as a rule being subsequently connected to a connection line. The selection of the suitable antenna for a specific application situation is of great importance. Depending on the environment, the installation situation, the maximum possible transmission power, and the type and alignment of the RFID transponders used, there will otherwise be signal damping that is possibly too large and that impairs or completely prevents communication between the RFID reading device and the transponder. A lot of technical knowledge is thus required on the part of the user so that the RFID reading device works at an optimum.

DE 103 53 613 A1 discloses a device for the setting and for the control of an RFID antenna that measures its antenna characteristics and adjusts them as required.

An RFID reader is described in EP 2 442 255 A1 whose antenna has a data carrier in which the antenna parameters are stored for a facilitated installation device, with the data carrier being able to be in particular an RFID transponder. Only identification information of the antenna can also be stored on the data carrier from which identification information the antenna parameters are determined by means of a table of the RFID reader or of a superior system.

An antenna for a write/read device for RFID arrangements is known from EP 2 712 021 A1. The antenna is equipped with a data store with type information and/or property information and furthermore has a measuring device for determining at least one value of the field strength or power of a radio frequency signal fed into the antenna.

U.S. Pat. No. 10,181,656 B2 deals with an antenna unit that has an antenna and a coaxial connector. The coaxial connector has an internal memory that makes it possible to identify the connected antenna and that is supplied via the coaxial cable.

US 2008/0129509 deals with an RFID system in which an antenna of an antenna arrangement is identified using a piece of information that is stored in an RFID tag of the antenna arrangement.

Possible adjustments of the antenna properties are only possible within the framework that the existing antenna sets in all of these cases.

U.S. Pat. No. 10,339,346 B2 discloses a reconfigurable antenna of an RFID reader in which a switch can be made between different antenna states to adjust properties such as the polarization, the frequency band, or the directional characteristic in the near and far fields. A plurality of connected antennas between which a change is made by the switchover are, however, required for this purpose.

It is therefore the object of the invention to further improve the communication of an RFID reading device with RFID transponders.

This object is satisfied by a method of testing and adjusting an RFID reading device and by an RFID reading device. The method is a computer implemented method that runs, for example, on a processing unit of the RFID reading device and/or a connected processing unit. The RFID reading device exchanges at least one RFID signal with at least one RFID transponder via the antenna. An RFID reading device is typically, despite the shortened name, also able to write data to an RFID transponder. The RFID reading device recognizes which antenna is connected, with this being able to be a specification in dependence on an embodiment still to be presented such as a parameter set by a user or an automatic identification of the antenna by the RFID reading device.

The invention starts from the basic idea that the RFID reading device, on the one hand, as explained has the knowledge of which antenna is connected and, on the other hand, has access to an antenna list which states which alternative antennas would be available. In this respect, antenna list means a collection of data with antennas in any desired data format. The existing antenna is then compared with the alternative antennas as to whether an improved transmission of the RFID signal will probably be achieved by an exchange. An antenna selected from the antenna list that results in an improvement is called an identified antenna. In this respect, improvement relates to at least one parameter of the transmission with the aim of exchanging RFID information in an improved manner, that is, for example, more robustly, with a higher reading rate, or also over a greater range between the RFID reading device and the RFID transponder. An alternative antenna having an improvement understood in this manner is then proposed to the user of the RFID reading device and is displayed at the device or at a different position for this purpose. This can all relate to an internal antenna provided that its exchange is, for example, provided by a modular design of the RFID reading device and is preferably simply possible or to an external antenna, with then its connection line being able to be included in the proposal for an exchange or to both provided that a connection possibility for an external antenna is provided in addition to an internal antenna.

The invention has the advantage that the communication between the RFID reading device and the RFID transponders to be read by it is improved after an exchange to a recommended antenna and thus the set object is satisfied. The proposals do not require any special training or technical knowledge of RFIDs, antennas, or the application situation. The signal quality is increased and thus the identification of RFID transponders and thus of the objects marked thereby is ultimately facilitated and improved.

The antenna list has entries for an antenna or for a connection line with associated antenna parameters or transmission parameters, in particular a damping, an antenna gain, an axial ratio, or a frequency range. The alternative antennas or connection lines are thus linked to properties with reference to which a decision can be made on whether an improvement is possible therewith or not. The antenna list together with the associated antenna parameters or transmission parameters is preferably combined in a uniform data format. Alternatively, the associated parameters can be derived in a second step using the identity of the antenna, for example by a database query.

At least one signal parameter of the transmitted RFID signal is preferably measured. In this manner, the RFID reading device can acquire information on how well the adjustment to the existing application situation has been implemented with the connected antenna. This serves as a basis for the comparison with alternative antennas and possible improvements by a replacement of the connected antenna with an alternative antenna. The measurements can take place during operation, but also during a configuration phase or teaching phase. A measurement is preferably made with the same RFID transponder or even more preferably with a plurality of RFID transponders during a plurality of read and/or write procedures to be able to evaluate the application and the adjustment in as representative a manner as possible.

The measured signal parameter is preferably compared with a minimum requirement. This minimum requirement can be fixedly specified, for instance by a user input or by a specification of the RFID reading device. A further possibility comprises deriving the minimum requirement from such specifications, for example to determine which signal strength is required for a specified range in the RFID reading device using a model or other computing rules. The identified antenna and/or connection line is/are then in particular identified when the measured signal parameter does not satisfy the minimum requirement. The improvement proposal of the RFID reading device is thus linked to the condition of the minimum requirement.

The measured signal parameter preferably has a signal strength, with the identified antenna in particular having a different antenna gain and/or the connection line having a different damping. The signal strength is frequently a particularly important parameter of the transmission for the RFID communication because the robustness and the range are very greatly dependent thereon. The proposed alternative antenna or connection line will therefore preferably achieve a higher signal strength, for instance by a higher antenna gain or a smaller damping. The term “different” respectively refers to the relationship between the connected antenna or existing antenna and the proposed alternative antenna or the alternative antenna provided for a replacement.

The identified antenna and/or connection line preferably results/result in a signal strength that is permitted in accordance with legal specifications and that is in particular just permitted. An antenna or connection line provided for replacement thus satisfies a standardized framework and, on the other hand, exploits if fully where possible. This can be understood as a condition that no proposal for an antenna infringes standard specifications, but also as an improvement in the sense that the previously connected antenna would infringe the legal specifications. In this case, a smaller signal strength than before is an improvement because admittedly nothing is gained from a technical viewpoint and to the contrary even a certain loss has to be accepted, but the RFID reading device would otherwise not be able to operate at all.

The time behavior of the signal strength is preferably checked for fluctuations and the identified antenna in particular has a different axial ratio or a different polarization in the case of fluctuations beyond a specified minimum degree. Strong fluctuations in the signal strength are here due to the fact that the RFID transponders have different alignments and the connected antenna only matches some of these alignments. It can be advantageous in this case to switch to an antenna having a smaller axial ratio or a different polarization, that is to illustratively adapt the alignment and eccentricity to an elliptical directional characteristic and beyond this, for example, to change from a linearly polarized antenna to a circularly polarized antenna. The threshold named as the minimum degree and applied to the fluctuations can be understood as one of the minimum requirements already listed above.

The measured signal parameter preferably has a frequency or a phase of the RFID signal. Some further signal parameters are thus named by way of example which can be responded to by replacement with an antenna of suitable antenna parameters. Some possible antenna parameters are: polarization, radiation resistance, impedance, efficiency, directional factor, antenna gain, absorption surface or effective surface, or bandwidth.

The connected antenna is preferably automatically recognized. A code at the antenna, including its connection line, can be recognized by an internal code reader or by a connected optical code reader for this purpose. A further possibility is the reading of a memory of the antenna, with the data exchange being able to take place over the connection line or wirelessly. The memory can in particular be implemented as an RFID transponder with which the RFID reading device communicates over RFID signals. A parameterization or user specification is conceivable as an alternative to an automatic recognition.

The antenna list is preferably stored on the RFID reading device. The RFID reading device thereby immediately has access. It is additionally or alternatively conceivable that the RFID reading device has access to an external database having the antenna list. The external database is, for example, implemented in a superior controller, a network, or a cloud.

The identified antenna and/or connection line is/are preferably displayed on a display of the RFID reading device or on a device connected thereto. The display can thus in principle be provided at the same locations as the antenna list, that is directly at the RFID reading device itself or also at a different device connected on site or also remotely.

In a preferred further development, an RFID reading device has an internal antenna or an external antenna connected via a connection line, a transceiver connected to the antenna to transmit at least one RFID signal between the RFID reading device and at least one RFID transponder, and a control and evaluation unit that is connected to the transceiver and in which a method in accordance with the invention of testing and adjusting the RFID reading device is implemented. The antenna is used by the RFID reading device to transmit RFID signals to an RFID transponder and/or to receive RFID signals from an RFID transponder. Any combination of a transmitter and receiver is called a transceiver here. The control and evaluation unit that has at least one digital processing module such as a microprocessor, an FPGA (field programmable gate array), an ASIC (application specific integrated circuit), or the like is configured or the encoding of RFID information into the RFID signals and/or to read RFID information from the RFID signals. The transceiver and control and evaluation unit can form a common processing module or can at least partially use a processing module together. Such an RFID reading device is preferably used in a stationary installation at a reading zone of a conveyor or of a reading portal for reading at least one RFID transponder moved on the conveyor or through the reading portal.

The invention will be explained in more detail in the following also with respect to further features and advantages by way of example with reference to embodiments and to the enclosed drawing. The Figures of the drawing show in:

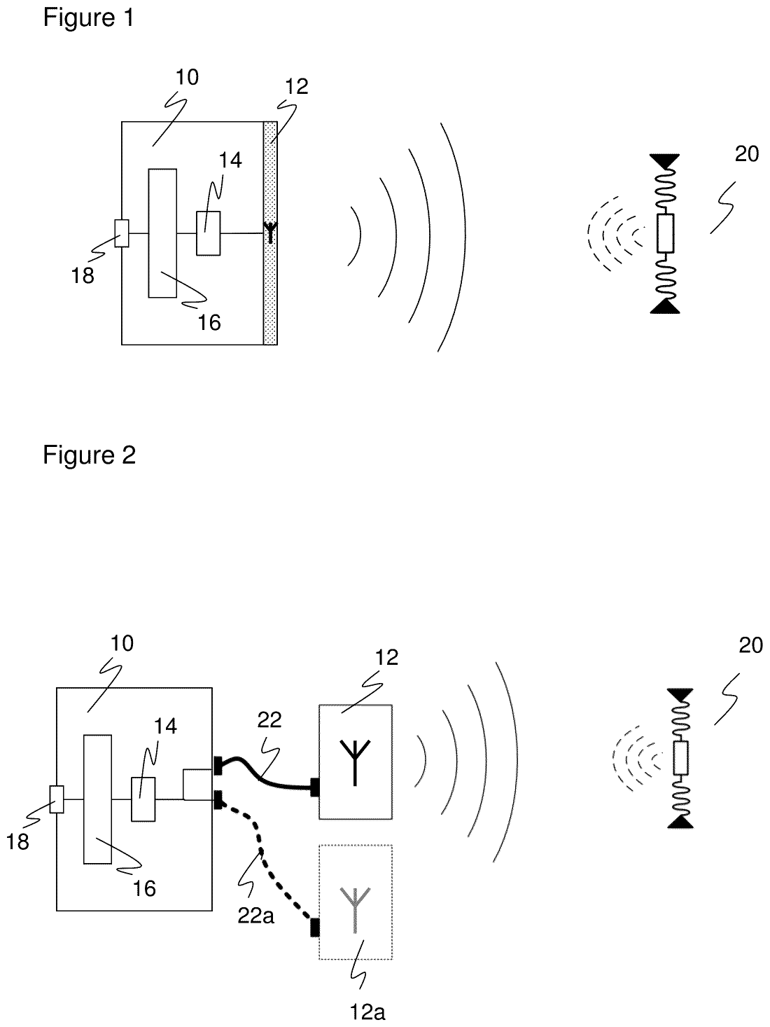

FIG. 1 a schematic representation of an RFID reading device with an internal antenna;

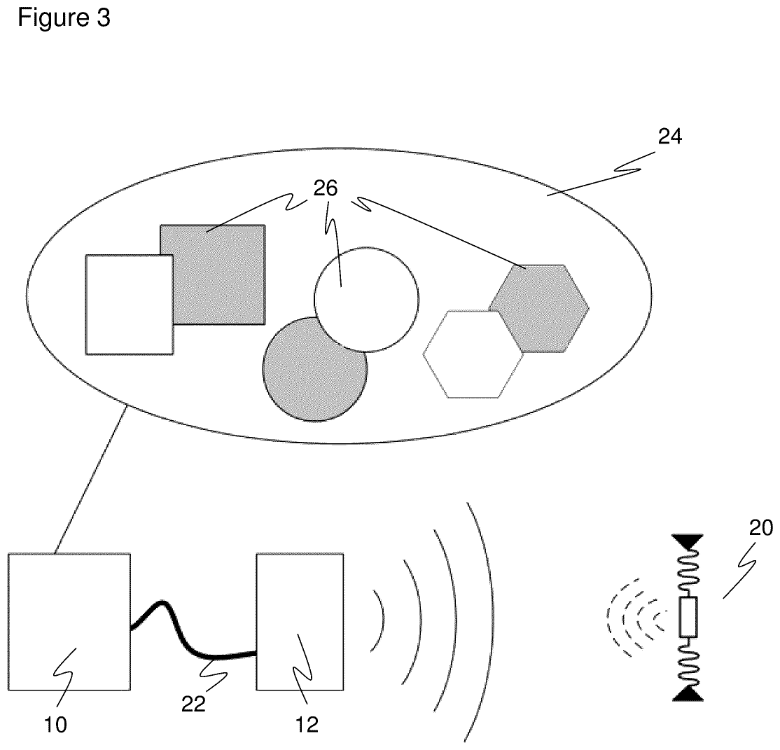

FIG. 2 a schematic representation of an RFID reading device with an external antenna;

FIG. 3 a schematic overview representation of an RFID reading device with access to an antenna list having alternatively connectable antennas;

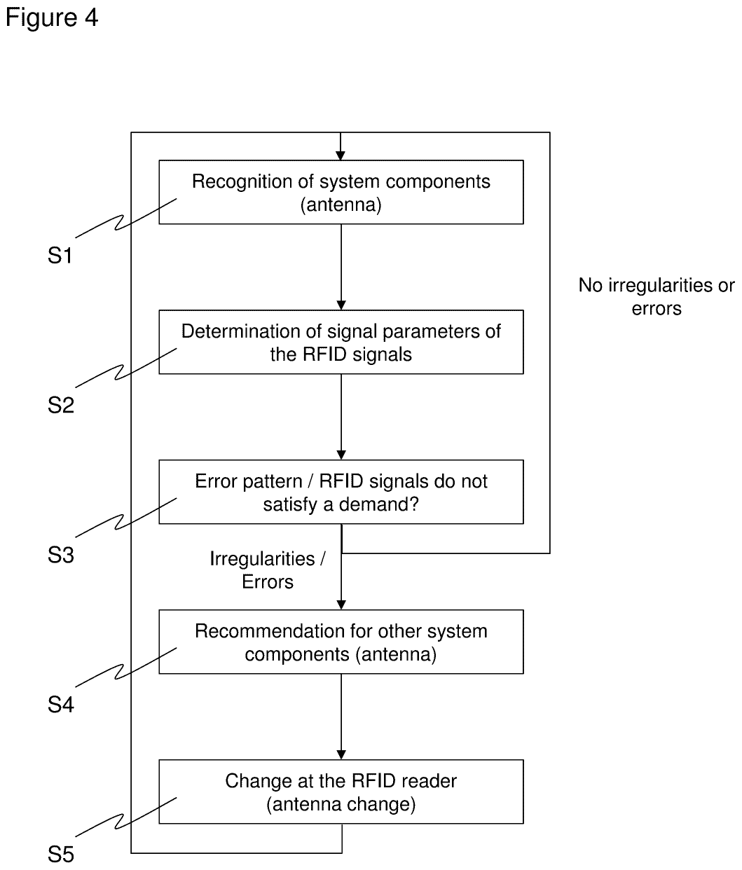

FIG. 4 an exemplary general flowchart to explain the adjustment of the RFID reading device by recommendation of a different antenna having improved antennas; and

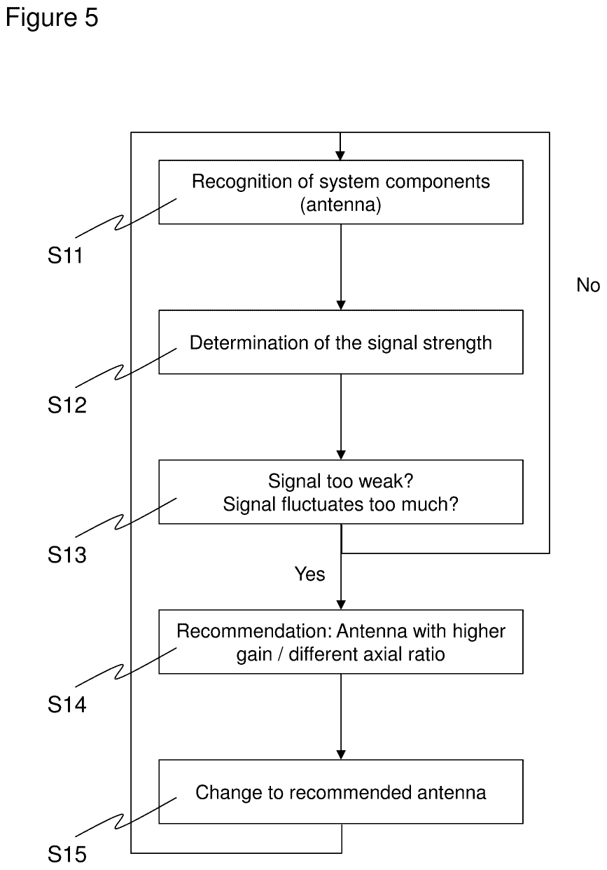

FIG. 5 a flowchart similar to FIG. 4, now with more specific conditions and recommendations of an embodiment.

FIG. 1 shows a schematic representation of an RFID reading device 10 having an antenna 12 that is here provided as an internal antenna. The antenna 12 is adapted to the ISM band at approximately 900 MHZ, for example. A transceiver 14 is connected to the antenna 12 and a control and evaluation unit 16 of the RFID reading device 10 is connected to the transceiver 14. The control and evaluation unit 16 is furthermore connected to a wired or wireless interface 18 to exchange data, to carry out parameterizations and the like. Information is transmitted by the control and evaluation unit 16 by means of the antenna 12 as RFID signals to an RFID transponder 20 or RFID signals received from the RFID transponder 20 are evaluated. The general function of an RFID reading device, for example for the UHF frequency range (ultrahigh frequency) in accordance with the standard ISO 18000-6, is known per se and will therefore not be explained in more detail

FIG. 2 shows a schematic representation of a further embodiment of an RFID reading device 10, now having an antenna 12 that is connected externally via a connection line 22. It should be indicated by a further antenna 12a connected externally via a connection line 22a that an RFID reading device 10 can communicate via a plurality of antennas, whether in parallel or by a switchover to a respective active antenna, with the number not being fixed at two antennas and a combination of internal and external antennas also being possible.

FIG. 3 shows a schematic overview representation of an RFID reading device 10 with access to a catalog or to an antenna list 24 having alternative antennas 26. Access means that the antenna list 24 is stored on the RFID reading device 10, the RFID reading device 10 can access it via its interface 18, or both. The alternative antennas 26 can be connected to the RFID reading device 10 instead of an external antenna 12, 12a, depending on the design of the RFID reading device 10 also instead of an internal antenna 12. The antenna list 24 can have any desired data format, with at least one piece of identification information being present for every alternative antenna by which it is recognized. Further properties such as the antenna parameters, size, connection type, permitted countries, an image, a datasheet, order information, and the like can be stored directly in the antenna list 24 with reference to the identification number or they are invoked from a local database or also from a database available on the internet or in a cloud with reference to the identification number.

The connection line 22 also has influence on the antenna properties so that entries can likewise be provided for this purpose in the antenna list 24, including properties of the connection line 22 such as its length or damping behavior. It is thus conceivable that the connection line 22 is also, or even only, replaced on the replacement of the antenna 12 with an alternative antenna 26. No difference in language is made at some points.

The purpose of the antenna list 24 is to make the setup, improvement, or adjustment of an application with the RFID reading device 10 easier for the user. For this purpose, the RFID reading device 10 should give the user a recommendation when there is an alternative antenna 26 on the antenna list 24 by which the RFID communication would be improved with respect to the existing antenna 12 or a desired specification of the application, for instance with respect to range, reading rate, or signal quality could only be achieved at all. A corresponding method for an automatic recommendation of an alternative antenna 26 will now first be explained with reference to FIG. 4 in a general form and then with reference to FIG. 5 in a particularly advantageous, more specific embodiment.

FIG. 4 shows an exemplary general flowchart to explain the adjustment of the RFID reading device 10 by a recommendation of an alternative antenna 26 from the antenna list 24 by which an RFID reading device 10 having improved properties for its application results.

In a step S1, the RFID reading device 10 recognizes which antenna 12 is connected. It must be pointed out that the term antenna is representative for system components that have an influence on the signal quality of the replaced RFID signals and can in particular include the connection line 22. In a simple embodiment, the connected antenna 12 is parameterized, the user, for example, enters the used components in a configuration program on the setting up of the system, for example. The recognition preferably takes place automatically to avoid this effort for the user as well as possible incorrect entries. The antenna 12 can, for example, have a memory for this purpose, in particular in the form of its own RFID transponder in which its own identification information is stored. The antenna 12 can then be identified in a wired manner or wirelessly, and particularly advantageously via the anyway implemented RFID protocol. A further variant is the attachment of an optical code that the RFID reading device 10 detects by a corresponding internally or externally connected optical code reader, not shown.

In a step S2, the RFID reading device 10 determines at least one signal parameter of the transmitted and/or received RFID signals. The RFID signal exchange that is possible with the connected antenna 12 is then subsequently thereby evaluated in step S3. Alternatively or additionally, the evaluation takes place theoretically using properties of the connected antenna, for example from its datasheet. The connected antenna 12 will as a rule have a dual role as one of the alternative antennas 26 of the antenna list 24 so that such information is available. Corresponding antenna parameters can otherwise be stored in the antenna 12 itself or can be invoked from a database with reference to their identification information. The detection of the at least one signal parameter of step S2 can take place during operation just as in a specific setup or maintenance mode. RFID signals of a repeated signal exchange can be evaluated by the same RFID transponder 20 and/or by a plurality of RFID transponders 20 to obtain a more reliable evaluation by wider statistics. Some conceivable signal parameters for the evaluation include the signal strength or the signal level, the phasing of the response signal, or a frequency shift.

In a step S3, the signal parameters detected in step S2 are evaluated as to whether an error pattern can be exemplified thereat or whether a set demand has not been satisfied. For example, minimum or maximum values are specified for signal parameters or a check is made whether signal parameters are subject to a large fluctuation. It is conceivable that requirements are set in a form from which specific threshold values or similar evaluation criteria can be derived at all, for example a required signal strength from a specified range.

If no such irregularities or errors are found, a replacement of the antenna 12 is not required and the method is ended or it can be repeated immediately or at a later time in step S1. The method is continued in a step S4 in the case of irregularities or errors. It is also conceivable to continue in step S4 in every case to also then propose an alternative antenna 26 when all the demands are instantaneously satisfied and to allow the user to decide whether nevertheless the antenna 12 should be replaced, for example to provide functional reserves.

A check is made in step S4 as to which of the alternative antennas 26 would correct the irregularities or the error found in step S3 in accordance with the antenna information available for this purpose with the antenna list 24. It can also be a simple improvement proposal that would, for example, permit a greater reading range. Care is preferably taken here that there are not only technical conditions. RFID systems are subject to standardized limit values, in particular with respect to the maximum irradiated power, that typically differ from country to country. A recommended alternative antenna 26 preferably observes such country specific limit values and even more preferably exhausts them.

In a step S5, the alternative antenna 26 identified in step S4 is displayed to the user, either on a display of the RFID reading device 10 itself or on a display directly connected thereto or also on a display connected via a network. This is preferably accompanied by additional information, for instance the cause of the recommendation, that is the error pattern corrected in this manner or the improvements achieved by an antenna replacement, or assembly instructions or an acquisition possibility for the recommended alternative antenna 26. The replacement itself takes place by the user, whereupon the method is repeated immediately or at a later time in step S1. It is conceivable that a plurality of antennas 12 are connected and/or the connected antennas 12 have variable, controllable properties. In particular supplementary automatic adjustments are also conceivable, for instance the switchover of a polarization.

FIG. 5 shows a flowchart similar to FIG. 4, now with more specific conditions and recommendations of an embodiment. Steps S11 to S15 are here largely analog to steps S1 to S5 and only the exemplary concretizations are explained.

Once the connected antenna 12 has been identified in step S11, specifically the signal strength (signal level, RSSI) is measured as the signal parameter in step S12. Too weak a signal that is, for example, below a signal strength threshold fixed or parameterized for the RFID reading device 10, for example, is understood as an error or as an irregularity in step S13. A further possible irregularity is a greatly fluctuating signal strength that can in turn be exemplified at thresholds or relationships fixed or parameterized for the RFID reading device 10.

If an irregularity has been recognized in step S13, the search for an alternative antenna 26 that corrects the irregularity takes place in step S14. A connection line 22 having smaller losses and/or an alternative antenna 26 having a higher antenna gain, for instance an alternative antenna 26 having 6 dBi instead of a connected antenna 12 having 3 dBi, can be recommended, for example, for the compensation of too low a signal strength. A greatly fluctuating signal strength indicates RFID transponders 20 at different distances and/or alignments. It is possible to respond only to signals only occasionally weak due to the distance in the same way as for signals that are too weak overall. Different alignments can be compensated, for example, by an alternative antenna 26 having a smaller axial ratio or a circular polarization instead of a linear polarization.

The identified alternative antenna 26 is displayed to the user in a step S15 that can then improve the RFID reading device by a replacement of the connected antenna 12 with the identified alternative antenna 26.

1. A method of testing and adjusting an RFID reading device that has an internal antenna and/or an external antenna connected via a connection line, wherein at least one RFID signal is transmitted between the RFID reading device and at least one RFID transponder over the antenna, and wherein the RFID reading device recognizes which antenna is connected, wherein the RFID reading device compares the connected antenna and/or the connection line with antennas connectable to the RFID reading device and/or with connection lines of an antenna list to identify an antenna and/or connection line that improves the transmission of the RFID signal and the identified antenna and/or connection line is/are displayed to a user of the RFID reading device.

2. The method in accordance with claim 1,
wherein the antenna list has entries for an antenna or for a connection line with associated antenna parameters or transmission parameters.

3. The method in accordance with claim 2,
wherein the antenna parameters and/or the transmission parameters comprise one of a damping, an antenna gain, an axial ratio, and a frequency range.

4. The method in accordance with claim 1,
wherein at least one signal parameter of the transmitted RFID signal is measured.

5. The method in accordance with claim 4,
wherein the measured signal parameter is compared with a minimum demand.

6. The method in accordance with claim 5,
wherein the identified antenna and/or connection line is/are displayed when the measured signal parameter does not satisfy the minimum demand.

7. The method in accordance with claim 4,
wherein the measured signal parameter has a signal strength.

8. The method in accordance with claim 7,
wherein the identified antenna has a different antenna gain and/or the connection line has a different damping.

9. The method in accordance with claim 1,
wherein the identified antenna and/or connection line results/result in a signal strength that is permitted tin accordance with legal specifications and that is in particular just permitted.

10. The method in accordance with claim 7,
wherein the time behavior of the signal strength is checked for fluctuations and the identified antenna.

11. The method in accordance with claim 10,
wherein the time behavior of the signal strength has a different axial ratio or a different polarization in the case of fluctuations beyond a specified minimum degree.

12. The method in accordance with claim 1,
wherein the time behavior of the signal strength is checked for fluctuations and the identified antenna.

13. The method in accordance with claim 12,
wherein the time behavior of the signal strength has a different axial ratio or a different polarization in the case of fluctuations beyond a specified minimum degree.

14. The method in accordance with claim 4,
wherein the measured signal parameter has a frequency or a phase of the RFID signal.

15. The method in accordance with claim 1,
wherein the connected antenna is automatically recognized.

16. The method in accordance with claim 15,
wherein the connected antenna is automatically recognized by recognition of an optical code of the antenna or by reading a memory of the antenna.

17. The method in accordance with claim 1,
wherein the antenna list is stored on the RFID reading device.

18. The method in accordance with claim 1,
wherein the RFID reading device has access to an external database having the antenna list.

19. The method in accordance with claims,
wherein the identified antenna and/or connection line is/are displayed on a display of the RFID reading device or on a device connected thereto.

20. An RFID reading device having an internal antenna and/or an external antenna connected via a connection line, a transceiver connected to the antenna to transmit at least one RFID signal between the RFID reading device and at least one RFID transponder, and a control and evaluation unit that is connected to the transceiver and in which a method of testing and adjusting the RFID reading device in accordance with claim 1, is implemented.
